(19) United States
(12) Patent Application Publication
(10) Pub. No.: US 2016/0024337 A1
(43) Pub. Date: Jan. 28, 2016

(54) Coating Compositions Having Hydroxyl Phenyl Functional Polymers

(71) Applicants: AKZO NOBEL COATINGS INTERNATIONAL B.V., Arnhem (NL); SI GROUP, INC., Schenectady, NY (US)

(72) Inventors: Daniel Bode, Cleveland, OH (US); Timothy Edward Banach, Scotia, NY (US); Gary Joseph Robideau, Niskayuna, NY (US); Leigh Scott Howard, Ballston Spa, NY (US); Gary Pierce Craun, Berea, OH (US); Guy John Stella, Cleveland Heights, OH (US)

(21) Appl. No.: 14/776,097

(22) PCT Filed: Mar. 14, 2014
(86) PCT No.: PCT/EP2014/055046

§ 371 Date: Sep. 14, 2015

Related U.S. Application Data
(60) Provisional application No. 61/790,805, filed on Mar. 15, 2013.

(30) Foreign Application Priority Data
Jul. 30, 2013 (EP) 13178513.1

(51) Int. Cl. C09D 167/06

(52) U.S. Cl. CPC C09D 167/06

(57) ABSTRACT

Coating compositions are disclosed. In some embodiments, the coating compositions are used to coat substrates such as packaging materials and the like for the storage of food and beverages. The coating compositions can be prepared from a hydroxyl phenyl functional polymer, a phenolic crosslinker, and a non-aqueous solvent, wherein the hydroxyl phenyl functional polymer is prepared using a phenol stearic acid compound, and wherein the acid number of the hydroxyl phenyl functional polymer is less than about 30 mg KOH/resin.

### BACKGROUND OF THE INVENTION

1. Field of the Invention

The present invention relates to hydroxyl phenyl functional polymers, coating compositions having hydroxyl phenyl functional polymers, methods of coating substrates with the coating compositions, and substrates coated with the coating compositions.

2. Description of Related Art

Many coating compositions currently used in the packaging coatings industry having do not cure well when blended with phenolic resin crosslinkers. Melamine and benzoguanamine have been used as co-crosslinkers with phenolic resins to crosslink polyesters and cure has improved, but it is desired in the packaging coatings industry to avoid triazines, such as melamine and benzoguanamine, for health reasons. Isocyanates have been used as crosslinkers for polyesters, but the resulting coating compositions have less corrosion resistance compared to coating compositions crosslinked with phenolic crosslinkers, plus it is desired in the packaging coatings industry to avoid using isocyanates for health reasons. Phenol-terminated polyesters have been crosslinked with melamine crosslinkers, but melamine is undesirable for health reasons as mentioned above. Polyesters have also been terminated with p-hydroxybenzoic acid, but it is also desired in the packaging coatings industry to avoid hydroxybenzoic acids, as parabens are materials of high concern. Polyesters formed from the reaction product of polyols and bis-epoxies reacted with phenolic carboxylic acids/esters are also used, but carboxylic phenols are also undesired in the packaging coatings industry for health reasons. Polyesters have also been terminated with phenols from cardanol, a known sensitizer, but this is also a material of concern.

There is a desire among some consumers and brand owners in the packaging coatings industry to have coating compositions which are also free, or substantially free, of bisphenol A and polyvinyl chloride and which do not suffer from the above drawbacks.

### SUMMARY OF THE INVENTION

The present invention relates to hydroxyl phenyl functional polymers, coating compositions having hydroxyl phenyl functional polymers, methods of coating substrates with the coating compositions, and substrates coated with the coating compositions. In some embodiments, the hydroxyl phenyl functional polymer is prepared from a phenol stearic acid compound. As used herein, the term “phenol stearic acid compound” is a compound prepared from the reaction product of oleic acid and a phenol, wherein the primary reaction product is 10-(p-hydroxyphenyl)-octadecanoic acid (also known as 9(10)-(hydroxyphenyl) octadecanoic acid), and wherein other materials formed from the reaction of oleic acid and phenol may be present in the reaction product.

The hydroxyl phenyl functional polymers can crosslink with phenolic resins to produce coating compositions having excellent flexibility, hardness and resistance to attack by foods and beverages. The coating compositions of the invention can be used as packaging coatings for food and beverages, among other things.

In some embodiments of the invention, a coating composition comprises a hydroxyl phenyl functional polymer, a phenolic crosslinker, and a non-aqueous solvent, wherein the hydroxyl phenyl functional polymer is prepared using a phenol stearic acid compound, and wherein the acid number of the hydroxyl phenyl functional polymer is less than about 30 mg KOH/resin. In some embodiments of the invention, a coating composition is prepared by reacting a phenol stearic acid compound, a diacid and a diol to produce a hydroxyl phenyl functional polymer, and blending the hydroxyl phenyl functional polymer with a phenolic crosslinker in the presence of a non-aqueous solvent to form the coating composition, wherein the acid number of the hydroxyl phenyl functional polymer is less than about 30 mg KOH/resin.

In some embodiments, the present invention includes methods of coating a substrate by applying the coating composition to the substrate. Substrates coated with the coating compositions are also disclosed. In some embodiments, the substrate is a can or packaging.

### DETAILED DESCRIPTION OF THE INVENTION

As used in the afore-discussed embodiments and other embodiments of the disclosure and claims described herein, the following terms generally have the meaning as indicated, but these meanings are not meant to limit the scope of the invention if the benefit of the invention is achieved by inferring a broader meaning to the following terms.

The present invention includes substrates coated at least in part with a coating composition of the invention and methods for coating the substrates. The term “substrate” as used herein includes, without limitation, cans, metal cans, easy-open-ends, packaging, containers, receptacles, or any portions thereof used to hold, touch or contact any type of food or beverage. Also, the terms “substrate”, “food can(s)”, “food containers” and the like include, for non-limiting example, “can ends”, which can be stamped from can end stock and used in the packaging of food and beverages. The present invention includes a coating composition comprising a hydroxyl phenyl functional polymer, a phenolic crosslinker, and a non-aqueous solvent, wherein the hydroxyl phenyl functional polymer is prepared using a phenol stearic acid compound, and wherein the acid number of the hydroxyl phenyl functional polymer is less than about 30 mg KOH/resin. The phenol stearic acid compound is present in an amount from about 5% to about 50 wt % of the hydroxyl phenyl functional polymer.

In some embodiments of the invention, a coating composition is prepared by reacting a phenol stearic acid compound, a diacid and a diol to produce a hydroxyl phenyl functional polymer, and blending the hydroxyl phenyl functional polymer with a phenolic crosslinker in the presence of a non-aqueous solvent to form the coating composition, wherein the acid number of the hydroxyl phenyl functional polymer is less than about 30 mg KOH/resin.

A monomer component may react with the phenol stearic acid compound to produce a hydroxyl phenyl functional polymer. The polymer may be a polyester, an acrylic compound, a polyamide, an epoxy resin, and the like, or a combination thereof For non-limiting example, when the polymer is a polyester, the polyester can be prepared from a diol and a diacid such that hydroxyl, amine, or glycidyl groups are available to react with the acid of the phenol stearic acid compound. The hydroxyl functional phenyl polymer is preferably not formed from a polyoxyalkylene compound since they do not provide sufficient retort resistance and food pack resistance required for metal packaging applications.

For non-limiting example, the hydroxyl phenyl functional polymer may be prepared from an ethylenically unsaturated monomer component having non-functional ethylenically unsaturated monomers such as, for non-limiting example, butyl acrylate, methyl methacrylate, styrene, benzyl methacrylate and the like and mixtures thereof, and optionally with lesser amounts of functional monomers such as, for non-limiting example, hydroxy propyl methacrylate, hydroxy ethyl acrylate, glycidyl methacrylate, acrylic acid, methacrylic acid, acetoacetoxy ethyl methacrylate, phosphate esters monomethacrylate and the like and mixtures thereof In some embodiments of the invention, the hydroxyl functional monomer is added at a level up to about 30% by weight of the ethylenically unsaturated monomer component mixture, the acid functional monomer is added at a level up to about 30% by weight of the ethylenically unsaturated monomer component mixture. In some embodiments, acetoacetoxy ethyl methacrylate is added at a level up to about 30% by weight of the ethylenically unsaturated monomer component mixture. Phosphate esters of monomethacrylates (such as Sipomer Pam-100, Pam-200 and Pam-400) can be added at a level up to about 20% by weight of the ethylenically unsaturated monomer component mixture. In some embodiments, about 10 to about 50% by weight of the ethylenically unsaturated monomer component mixture is an acid functional monomer. In some embodiments, the acid functional monomer is methacrylic acid.

In certain embodiments, glycidyl methacrylate is used at levels of about 10 to about 20% by weight of the ethylenically unsaturated monomer component mixture, and the phenol stearic acid compound, is adducted with the acrylic polymer after it is formed.

The initiator used to polymerize the ethylenically unsaturated monomers may include without limitation, azo compounds such as for non-limiting example, 2,2′-azo-bis(isobutyronitrile), 2,2′-azo-bis(2,4-dimethylvaleronitrile), and 1-t-butyl-azocyanocyclohexane), hydroperoxides such as for non-limiting example, t-butyl hydroperoxide and cumene hydroperoxide, peroxides such as for non-limiting example, benzoyl peroxide, caprylyl peroxide, di-t-butyl peroxide, ethyl 3,3′-di(t-butylperoxy) butyrate, ethyl 3,3′-di(t-amylperoxy) butyrate, t-amylperoxy-2-ethyl hexanoate, 1,1,3,3-tetramethylbutyl-peroxy-2-ethylhexanoate, and t-butylperoxy pivilate, peresters such as for non-limiting example, t-butyl peracetate, t-butyl perphthalate, and t-butyl perbenzoate, as well as percarbonates, such as for non-limiting example, di(1-cyano-1-methylethyl)peroxy dicarbonate, perphosphates, t-butyl peroctoate, and the like and mixtures thereof In some embodiments, the initiator is present in an amount from about 0.1 to about 15%, and alternatively from about 1 to about 5%, based on the weight of the monomer mixture. In some embodiments, the initiator is added over about 2 hours, simultaneously with the monomers as a feed to a solvent mixture, held at a suitable temperature relative to the half-life of the initiator.

Epoxidized vegetable oils can be used as the epoxy resin used to form the hydroxyl phenyl functional polymer. Epoxidized vegetable oils can be prepared from vegetable oils by, for non-limiting example, adding hydrogen peroxide and formic or acetic acid to the vegetable oil, and then holding the mixture at an elevated temperature until some or all of the carbon-carbon double bonds are converted to epoxide groups.

Vegetable oils contain primarily glycerides which are triesters of glycerol and fatty acids with varying degrees of unsaturation. For non-limiting example, epoxidized vegetable oils for use in the invention can be made from vegetable oils (fatty acid triglycerides) such as without limitation, esters of glycerol and fatty acids having an alkyl chain of about 12 to about 24 carbon atoms. Fatty acid glycerides which are triglycerides in unsaturated glyceride oils are generally referred to as drying oils or semidrying oils. Drying oils include, for non-limiting example, linseed oil, perilla oil and combinations thereof, while semidrying oils include, without limitation, tall oil, soy bean oil, safflower oil and combinations thereof. Triglyceride oils in some embodiments have identical fatty acid chains or alternatively have different fatty acid chains attached to the same glycerol molecule. In some embodiments, the oils have fatty acid chains containing non-conjugated double bonds. In some embodiments, single double bond or conjugated double bond fatty acid chains are used in minor amounts. Double bond unsaturation in glycerides can be measured by iodine value (number) which indicates the degree of double bond unsaturation in the fatty acid chains. Unsaturated fatty acid glyceride oils employed in some embodiments of the invention have an iodine value greater than about 25 and alternatively between about 100 and about 210.

Naturally occurring vegetable oils for use in the invention can be for non-limiting example, mixtures of fatty acid chains present as glycerides, and include without limitation a distribution of fatty acid esters of glyceride, where the fatty acid distribution may be random but within an established range that may vary moderately depending on the growing conditions of the vegetable source. Soybean oil is employed in some embodiments which comprises approximately about 11% palmitic, about 4% stearic, about 25% oleic, about 51% linolenic, and about 9% linoleic fatty acids, where oleic, linoleic and linolenic are unsaturated fatty acids. Unsaturated vegetable oils employed in some embodiments of the invention, include without limitation, glyceride oils containing non-conjugated unsaturated fatty acid glyceride esters such as, without limitation, linoleic and linolenic fatty acids.

Unsaturated glyceride oils include, without limitation, corn oil, cottonseed oil, rapeseed oil, hempseed oil, linseed oil, wild mustard oil, peanut oil, perilla oil, poppyseed oil, rapeseed oil, safflower oil, sesame oil, soy bean oil, sunflower oil, canola oil, tall oil, and mixtures thereof Fatty acid glycerides for use in the invention include, for non-limiting example, those which contain linoleic and linolenic fatty acid chains, oils such as without limitation, hempseed oil, linseed oil, perilla oil, poppyseed oil, safflower oil, soy bean oil, sunflower oil, canola oil, tall oil, grapeseed oil, rattonseed oil, corn oil, and similar oils which contain high levels of linoleic and linolenic fatty acid glyceride. Glycerides can contain lesser amounts of saturated fatty acids in some embodiments. For non-limiting example, soy bean oil can be employed which contains predominantly linoleic and linolenic fatty acid glycerides. Combinations of such oils are employed in some embodiments of the invention. Vegetable oils can by fully or partially epoxidized by known processes, such as for non-limiting example, using acids such as, without limitation, peroxy acid for epoxidation of unsaturated double bonds of the unsaturated vegetable oil. Unsaturated glyceride oils employed in some embodiments include mono-, di-glycerides and mixtures thereof with tri-glycerides or fatty acid esters of saturated and unsaturated fatty acids. In some embodiments, the epoxidized vegetable oil comprises corn oil, cottonseed oil, grapeseed oil, hempseed oil, linseed oil, wild mustard oil, peanut oil, perilla oil, poppyseed oil, rapeseed oil, safflower oil, sesame oil, soy bean oil, sunflower oil, canola oil, tall oil, a fatty acid ester, monoglyceride or diglyceride of such oils, or a mixture thereof.

Commercially available sources of epoxidized vegetable oils are used in some embodiments of the invention such as, for non-limiting example, epoxidized soy oil sold under the trade designations “VIKOLOX” and “VIKOFLEX 7170” available from Arkema, Inc, “DRAPEX 6.8” available from Chemtura Corporation, and “PLAS-CHECK 775” available from Ferro Corp. Other epoxidized vegetable oils for use in the invention include, for non-limiting example, epoxidized linseed oil sold under the trade designations “VIKOFLEX 7190” available from Arkema, Inc. and “DRAPEX 10.4” available from Chemtura Corporation, epoxidized cotton seed oil, epoxidized carthamus oil and mixtures thereof. Epoxidized soy bean oil is employed in some embodiments.

In some embodiments of the invention, the hydroxyl functional material used to form the hydroxyl functional polymer by reaction with the epoxidized vegetable oil includes, without limitation, propylene glycol, ethylene glycol, 1,3-propane diol, neopentyl glycol, trimethylol propane, diethylene glycol, a polyether glycol, a polyester, a polycarbonate, a polyolefin, a hydroxyl functional polyolefin, and combinations thereof The hydroxyl functional material includes an alcohol in some embodiments such as, without limitation, n-butanol, 2-ethyl hexanol, benzyl alcohol, and the like, alone, or in combination with diols or polyols. Polyamides may be formed from diamines such as ethylene diamine, hexamethylene diamine, piperazine, and the like or mixtures thereof reacted with diacids such as isophthalic acid, adipic acid, dimer fatty acids, cyclohexanedioic acid, naphthalenedioic acid, terephthalic acid, and the like or mixture thereof. Triacids or triols may be included to provide branching. Technically, if a triol or any other glycols are included, the polymer is a polyester-amide. The phenol stearic acid compound may react either with the amine functionality or the hydroxyl functionality.

The acid number of the hydroxyl phenyl functional polymer is less than about 30 mg KOH/resin in certain embodiments of the invention. In other embodiments, the acid number is less than about 20 mg KOH/resin, less than about 10 mg KOH/resin, less than about 5 mg KOH/resin, or less than about 3 mg KOH/resin. This acid number can improve pigment dispersion, substrate wetting, adhesion and corrosion resistance of the coating composition.

The hydroxyl phenyl functional polymers of the invention may be prepared in the presence of an acid catalyst. The acid catalyst can be without limitation a Lewis acid catalyst, a strong acid catalyst such as, for non-limiting example, one or more sulfonic acids or another strong acid (an acid with a pKa about 3 or less), a triflic acid, a triflate salt of a metal of Group IIA, IIB, IIIA, IIIB or VIIIA of the Periodic Table of Elements (according to the IUPAC 1970 convention), a mixture of said triflate salts, or a combination thereof. In some embodiments, the amount of acid catalyst can range from about 1 ppm to about 10,000 ppm, and alternatively from about 10 ppm to about 1,000 ppm, based on the total weight of the reaction mixture. Catalysts include, for non-limiting example, the Group IIA metal triflate catalysts such as without limitation magnesium triflate, the Group IIB metal triflate catalysts such as without limitation zinc and cadmium triflate, the Group IIIA metal triflate catalysts such as without limitation lanthanum triflate, the Group IIIB metal triflate catalysts such as without limitation aluminum triflate, and the Group VIIIA metal triflate catalysts such as without limitation cobalt triflate, and combinations thereof. The amount of each metal triflate catalyst can range, for non-limiting example, from about 10 to about 1,000 ppm, alternatively from about 10 to about 200 ppm, based on the total weight of the reaction mixture. Some embodiments of the invention employ a metal triflate catalyst in the form of a solution in an organic solvent. Examples of solvents include, without limitation, water, alcohols such as n-butanol, ethanol, propanol, and the like, as well as aromatic hydrocarbon solvents, cycloaliphatic polar solvents such as, for non-limiting example, cycloaliphatic ketones (e.g. cyclohexanone), polar aliphatic solvents, such as, for non-limiting example, alkoxyalkanols, 2-methoxyethanol, non hydroxyl functional solvents, and mixtures thereof.

In some embodiments, the compounds used to form the hydroxyl phenyl functional polymer are heated in the presence of a catalyst and a solvent (such as propylene glycol) to a temperature of about 50 to about 160° C. Optionally, another solvent (such as ethylene glycol monobutyl ether or diethylene glycol monoethyl ether) can be included in the synthesis of the epoxidized vegetable oil and hydroxyl functional material to help control viscosity. Suitable solvents include for non-limiting example, a ketone such as, without limitation, methyl amyl ketone, an aromatic solvent such as, without limitation, xylene or Aromatic 100, an ester solvent or other non-hydroxyl functional solvent, and mixtures thereof. Up to about 90% of a solvent based on the total weight reaction mixture is employed in various embodiments of the invention, and alternatively about 5 to about 30% is employed. Solvents selected from those described above as well as other solvents including, without limitation, hydroxyl functional solvents can be added upon cooling. In some embodiments, it is desirable to have a final NV (non-volatile content by weight) of about 30 to about 50.

In some embodiments, the hydroxyl phenyl functional polymer is crosslinked with a phenolic crosslinker to form a curable coating composition. The phenolic crosslinker may comprise a phenolic compound, a resole phenolic compound, a novolac compound, or a combination thereof The weight ratio of phenolic crosslinker to hydroxyl functional phenyl polyester may be from about 10/90 to about 40/60 at about 30-60% solids. The crosslinked coating composition may provide excellent film performance at very short baking for coil applications.

Optionally, the mixture of polymers and crosslinkers can occur in the presence of a cure catalyst. Cure catalysts include, for non-limiting example, dodecyl benzene sulfonic acid, p-toluene sulfonic acid, phosphoric acid, and the like and mixtures thereof. In some embodiments, other polymers may be blended into the coating composition, such as without limitation, polyethers, polyesters, polycarbonates, polyurethanes and the like, as well as mixtures thereof. Cure conditions for packaging coatings in some embodiments are about 5 to about 60 seconds at about 400° F. to about 600° F., and alternatively about 5 seconds to about 20 seconds at about 400° F. to about 500° F.

The copolymers and the coating compositions of the invention can include conventional additives known to those skilled in the art, such as without limitation, flow agents, surface active agents, defoamers, anti-cratering additives, lubricants, meat-release additives, and cure catalysts. In some embodiments of the invention, one or more coating compositions are applied to a substrate, such as for non-limiting example, cans, metal cans, easy-open-ends, packaging, containers, receptacles, can ends, or any portions thereof used to hold or touch any type of food or beverage. In some embodiments, one or more coatings are applied in addition to the coating compositions of the present invention, such as for non-limiting example, a prime coat may be applied between the substrate and the coating composition.

The coating compositions can be applied to substrates in any manner known to those skilled in the art. In some embodiments, the coating compositions are sprayed or roll coated onto a substrate.

When applied, the coating compositions contain, for non-limiting example, between about 20% and about 40% by weight polymeric solids relative to about 60% to about 80% solvent. For some applications, typically those other than spraying, solvent borne polymeric solutions can contain, for non-limiting example, between about 20% and about 60% by weight polymer solids. Organic solvents are utilized in some embodiments to facilitate roll coating or other application methods and such solvents can include, without limitation, n-butanol, 2-butoxy-ethanol-1, xylene, propylene glycol, N-butyl cellosolve, diethylene glycol monoethyl ether and other aromatic solvents and ester solvents, and mixtures thereof. In some embodiments, N-butyl cellosolve is used in combination with propylene glycol. The resulting coating compositions are applied in some embodiments by conventional methods known in the coating industry. Thus, for non-limiting example, spraying, rolling, dipping, coil coating and flow coating application methods can be used. In some embodiments, after application onto a substrate, the coating composition is thermally cured at temperatures in the range of about 200° C. to about 250° C., and alternatively higher for time sufficient to effect complete curing as well as volatilizing any fugitive components.

The coating compositions of the present invention can be pigmented and/or opacified with known pigments and opacifiers in some embodiments. For many uses, including food use for non-limiting example, the pigment can be zinc oxide, carbon black, or titanium dioxide. The resulting coating compositions are applied in some embodiments by conventional methods known in the coating industry. Thus, for non-limiting example, spraying, rolling, dipping, and flow coating application methods can be used for both clear and pigmented films. In some embodiments, after application onto a substrate, the coating composition is thermally cured at temperatures in the range of about 130° C. to about 250° C., and alternatively higher for time sufficient to effect complete curing as well as volatilizing any fugitive components.

For substrates intended as beverage containers, the coating are applied in some embodiments at a rate in the range from about 0.5 msi to about 15 milligrams per square inch of polymer coating per square inch of exposed substrate surface. In some embodiments, the water-dispersible coating is applied at a thickness between about 0.1 msi and about 1.15 msi.

For substrates intended as beverage easy-open-ends, the coating are applied in some embodiments at a rate in the range from about 1.5 to about 15 milligrams per square inch of polymer coating per square inch of exposed substrate surface. Conventional packaging coating compositions are applied to metal at about 232 to about 247° C. When used as a coating for the easy-open-end of a metal container, the coatings of the invention exhibit resistance to retorted beverages, acidified coffees, isotonic drinks, and the like. In some embodiments, the solids content of the coating composition is greater than about 30% and the coating composition has a viscosity from about 35 to about 200 centipoise at 30% solids or above to produce a film weight of about 6 to about 8 msi (milligrams per square inch) so that over blister is minimized and so that the film can have good chemical resistance, such as aluminum pick-up resistance. Some of the coating compositions of the current invention can be used for both inside and outside easy-open-end applications.

### EXAMPLES

The invention will be further described by reference to the following non-limiting examples. It should be understood that variations and modifications of these examples can be made by those skilled in the art without departing from the spirit and scope of the invention.

### Example 1

276.4 grams of unoxol diol (a 1,3-, 1,4-cyclohexane dimethanol blend), 9.2 grams of trimethylol propane, 208.4 grams of isophthalic acid, 104.2 grams of terephthalic acid, 103.2 grams of 10-(p-hydroxyphenyl)-octadecanoic acid, and 0.60 grams of butylstannoic acid were mixed and heated to about 185° C. The reaction temperature was controlled such that the head temperature on the distillation column did not exceed about 98° C. as the batch temperature was raised to 240° C. The batch was held at about 240° C. until the head temperature dropped below about 70° C. Water was distilled overhead for 2 hours, then switched to a xylene azeotrope. About 20 grams of xylene remained in the polyester. The polyester was cooked until the polyester had an acid number of about 1 mg KOH/gram. A 1:2 ratio of the solvents Aromatic 150 and Aromatic 100 were added on cool down to give a non-volatile content of 60%.

What is claimed is:

1. A coating composition comprising:
a) a hydroxyl phenyl functional polymer;
b) a phenolic crosslinker; and
c) a non-aqueous solvent;
wherein the hydroxyl phenyl functional polymer is prepared using a phenol stearic acid compound, and
wherein the acid number of the hydroxyl phenyl functional polymer is less than about 30 mg KOH/resin.

2. The coating composition of claim 1, wherein the phenol stearic acid compound comprises 10-(p-hydroxyphenyl)-octadecanoic acid.

3. The coating composition of claim 1, wherein the hydroxyl phenyl functional polymer is prepared in the presence of an acid catalyst.

4. The coating composition of claim 1, wherein the hydroxyl phenyl functional polymer is prepared from a polyester, an acrylic compound, a polyamide, an epoxy resin, or a combination thereof.

5. The coating composition of claim 1, wherein the phenol stearic acid compound is present in an amount from about 5% to about 50 wt % of the hydroxyl phenyl functional polymer.

6. The coating composition of claim 1, wherein the hydroxyl phenyl functional polymer is prepared using an ethylenically unsaturated monomer component.

7. The coating composition of claim 6, wherein the ethylenically unsaturated monomer component comprises butyl acrylate, methyl methacrylate, styrene, benzyl methacrylate, hydroxy propyl methacrylate, hydroxy ethyl acrylate, glycidyl methacrylate, acrylic acid, methacrylic acid, acetoacetoxy ethyl methacrylate, a phosphate ester monomethacrylate, or a mixture thereof.

8. A coating composition comprising prepared by a method comprising:
a) reacting a phenol stearic acid compound, a diacid and a diol to produce a hydroxyl phenyl functional polymer; and
b) blending the hydroxyl phenyl functional polymer with a phenolic crosslinker in the presence of a non-aqueous solvent to form the coating composition, wherein the acid number of the hydroxyl phenyl functional polymer is less than about 30 mg KOH/resin.

9. The coating composition of claim 8, wherein the phenol stearic acid compound comprises 10-(p-hydroxyphenyl)-octadecanoic acid.

10. The coating composition of claim 8, wherein the diacid comprises isophthalic acid, adipic acid, cyclohexanedioic acid, naphthalenedioic acid, terephthalic acid, or a mixture thereof.

11. The coating composition of claim 8, wherein the diol comprises neopentyl glycol, cyclohexane dimethanol, ethylene glycol, propylene glycol, 1,3-propane diol, trimethylol propane, diethylene glycol, a polyether glycol, benzyl alcohol, 2-ethyl hexanol, a polyester, a polycarbonate, a hydroxyl functional polyolefin, or a mixture thereofor a mixture thereof.

12. The coating composition of claim 8, wherein the hydroxyl phenyl functional polymer is prepared in the presence of an acid catalyst.

13. The coating composition of claim 8, wherein the hydroxyl phenyl functional polymer is prepared from a polyester, an acrylic compound, a polyamide, an epoxy resin, or a combination thereof.

14. The coating composition of claim 8, wherein the phenol stearic acid compound is present in an amount from about 5 to about 50% of the hydroxyl phenyl functional polymer.

15. The coating composition of claim 8, wherein the hydroxyl phenyl functional polymer is prepared using an ethylenically unsaturated monomer component.

16. The coating composition of claim 15, wherein the ethylenically unsaturated monomer component comprises butyl acrylate, methyl methacrylate, styrene, benzyl methacrylate, hydroxy propyl methacrylate, hydroxy ethyl acrylate, glycidyl methacrylate, acrylic acid, methacrylic acid, acetoacetoxy ethyl methacrylate, a phosphate ester monomethacrylate, or a mixture thereof.

17. A method of coating a substrate comprising applying the coating composition of claim 1 to a substrate.

18. A substrate coated with the coating composition of claim 1.
